(19) United States
(12) Patent Application Publication
(10) Pub. No.: US 2009/0279107 A1
(43) Pub. Date: Nov. 12, 2009

(54) OPTICAL DISTANCE MEASUREMENT BY TRIANGULATION OF AN ACTIVE TRANSPONDER

(75) Inventor: Shrenik DELIWALA, Andover, MA (US)

Correspondence Address: KENYON & KENYON LLP, 1500 K STREET, NW, WASHINGTON, DC, 20005-1257, US

(73) Assignee: ANALOG DEVICES, INC., Norwood, MA (US)

(21) Appl. No.: 12/435,499

(22) Filed: May 5, 2009

Related U.S. Application Data
(60) Provisional application No. 61/052,121, filed on May 9, 2008.
(60) Provisional application No. 61/052,125, filed on May 9, 2008.

(51) Int. Cl. G01B 11/14; G06F 15/00; A63F 13/00; A63F 9/24

(52) U.S. Cl. 356/623; 702/150; 463/30; 463/43

(57) ABSTRACT

Methods and devices for calculating the position of a movable device are disclosed. A console and movable device may include light detector(s) and light sources. A light source of the console may emit light that is detected by light detector(s) of the movable device. The moveable device may respond by emitting light synchronous with the received light. The console may calculate the position of the movable device by calculating the time for the light emitted from the movable device to strike the light detector(s) of the console. The rotation of the movable device may be calculated using multiple light sources and/or multiple light detector(s). The movable device may calculate its position and transmit it to a console. Multiple light sources may be distinguished using encoding or modulation of time and/or frequency. The roles of the light detectors(s) and light sources may be switched.

### CROSS REFERENCE TO RELATED APPLICATIONS

This application claims priority under 35 U.S.C. 119(e) to U.S. Provisional Application, 61,052,121, filed on May 9, 2008, with title “Method of Locating an Object in 3D”; and to U.S. Provisional Application 61,052,125, filed on May 9, 2008, with title “Optical Distance Measurement By Triangulation of an Active Transponder”.

### FIELD OF INVENTION

The present invention relates to calculating the position of a movable object, and more particularly to calculating the position of a movable object using light.

### BACKGROUND

The advantages of being able to calculate the location of a moveable device are enormous, but measuring the location of a movable device can be difficult. And many applications need to track a movable device by repeatedly measuring the location of the movable device. Some known devices have problems. Devices based on gyroscopes are prone to accumulating errors and need to be reset periodically. Devices based on measuring radio waves may suffer from interference from many other devices that generate radio waves. Devices based on videoing the real person or lights attached to the real person (or moveable device) and then calculating the person's (or movable device's) location by computational methods requires expensive hardware to implement. Additionally, it may be that the movable device is wireless so that the power source must be contained in the movable device.

Therefore, there is a need in the art for reliably calculating the position of a movable device that does not rely on radio waves or gyroscopes, and that may not have large power and/or computational requirements.

### BRIEF DESCRIPTION OF THE DRAWINGS

FIG. 1 illustrates a system according to an embodiment of the present invention.

FIG. 2A illustrates a system according to an embodiment of the present invention.

FIG. 2B illustrates a system according to an embodiment of the present invention.

FIG. 3 illustrates an embodiment for calculating the rotation of a movable device.

FIG. 4 illustrates an embodiment for calculating the rotation of a movable device.

FIG. 5 illustrates an embodiment for calculating the rotation of a movable device with multiple light sources.

FIG. 6 illustrates an embodiment of the present invention where the roles of the light sources and light detectors are reversed.

FIG. 7 illustrates an embodiment of the present invention of a controller.

FIG. 8 illustrates an embodiment of the present invention of a movable device.

FIG. 9 illustrates embodiments of the present invention.

### DETAILED DESCRIPTION

Embodiments of the present invention provide two light detectors, the light detectors each receiving light from a movable device and each generating electrical signals in response to the incident light. The light detectors may receive incident light directly from a light source mounted on the movable device or indirectly from a light source via a reflector mounted on the movable device. A controller communicatively coupled to the light detectors may calculate a position of the movable device from the electrical signals generated by the two light detectors and from a roundtrip time representing a time for the device to receive a response from the movable device in response to the light transmitted to the movable device.

The light detectors may receive incident light from the movable device light source and may generate electrical signals in response to the incident light from the light source. The system may further include a controller communicatively coupled to the light detectors to calculate a position of the movable device light source based on the electrical signals generated by the two light detectors in response to the incident light from the movable device light source and based on calculating a time to receive a response from the movable device light source in response to the light source.

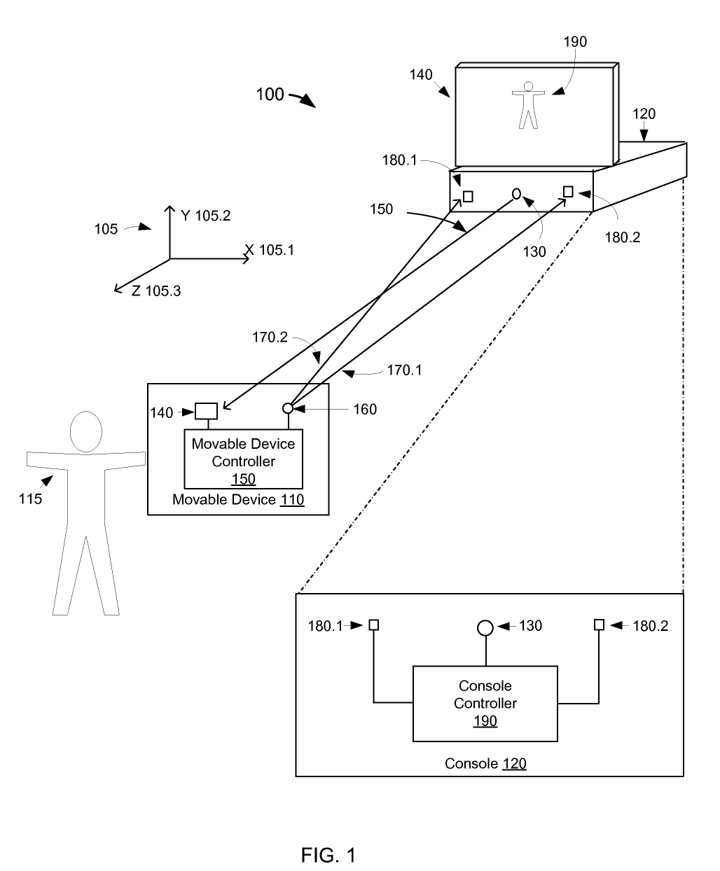

FIG. 1 illustrates a system 100 according to an embodiment of the present invention. The system 100 illustrates a game console 120 and a movable device 110. The game console 120 calculates a position 105 of the movable device 110 and may move an avatar 130 on a computer display 140 in response to calculated positions of the movable device 110. A person 115 may move the movable device 110.

The console 120 may include one or more light source(s) 130 that emit or reflect light 150 into free space. The light 150 strikes a light detector 140 of the movable device 110 which in response generates electrical signals. In response to the electrical signals generated at the light detector 140, the movable device controller 150 of the movable device 110 instructs the light source 160 to emit light 170 into free space. The incident light 170.1, 170.2 strikes the light detectors 180.1, 180.2 respectively, which in response generate electrical signals. In an embodiment, the position 105 of the light source 160, which is part of moveable device 110, may be measured based on a coordinate system with X 105.1, Y 105.2, and Z 105.3 coordinates and with an origin (not illustrated) at the console 120. The console controller 190 may calculate the Z 105.3 position of the light source 160 based on calculating how long it took for the light 170 to travel to the light detector 130. The console controller 190 may calculate the X 105.1 position based on the difference between the time it takes the light 170 to reach the two light detectors 180.1 and 180.2.

In an embodiment, the light source 160 emits modulated light 170. In an embodiment, the console controller 190 calculates the position X 105.1 based on a phase shift of the received light 170.1 and 170.2. In an embodiment, the console controller 190 calculates the position Z 105.3 of the movable device 110 based on a phase shift between the light 150 and the received light 170. In an embodiment, the console 120 may include a third light detector on a different axis than the axis formed by the two light detectors 180.1 and 180.2. In an embodiment, the console controller 190 may calculate the position Y 105.2 based on the difference between the time it takes the light 170 to reach at least one of the two light detectors 180.1 and 180.2 and the third light detector (not illustrated in FIG. 1.) The console controller 190 may track the movable device 110 by repeatedly calculating the position of the movable device 110.

In another embodiment, the light source 160 may reflect modulated light generated from a light generator (not shown) and transmitted to the light source 160. The light source 160 reflects the modulated light into free space, some of which may be received at the light detectors 130. The console controller 190 may calculate the device's 110 free space position using light sources 160 that reflect light rather than generate light.

In response to the electrical signals generated at the light detector 140, the movable device controller 150 of the movable device 110 instructs the light source 160 to emit light 170 into free space.

Calculating the Position of the Light Source

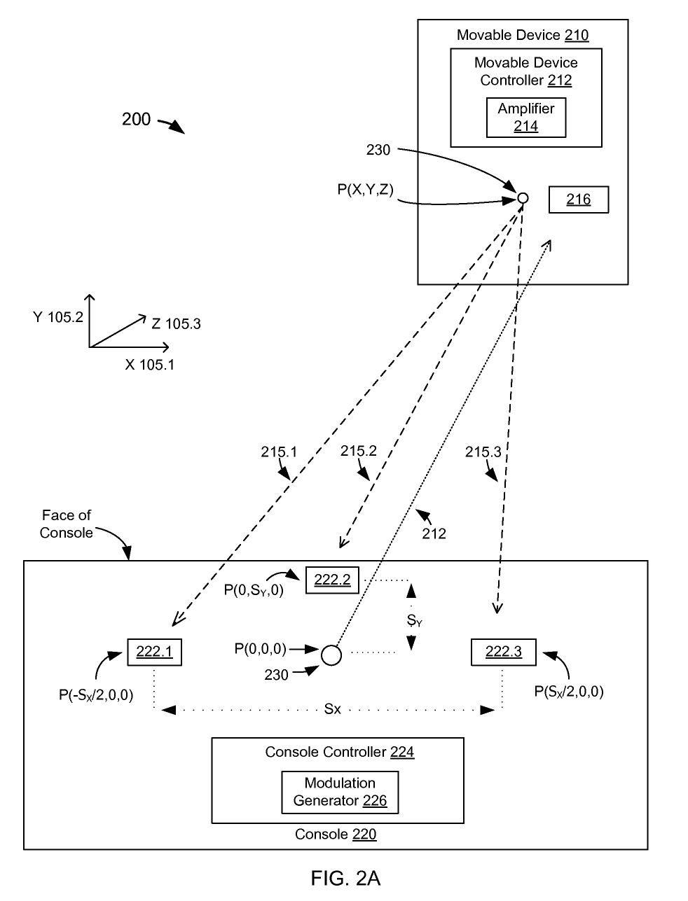

FIG. 2A illustrates a system 200 according to an embodiment of the present invention. The system 200 illustrates a console 220 and a movable device 210. The console 220 calculates a position P(X, Y, Z) of the movable device 210. The console 220 may include a light source 230, light detectors 240, and a console controller 250 which may include a modulation generator 260. The console controller 250 may be communicatively coupled to the light detectors 240 and the light source 230. For example, wires (not illustrated) may connect the console controller 224 to the light detectors 222. The movable device 210 may include a light source 216, and light detector 218, and a movable device controller 212, which may include an amplifier 214. The movable device controller 212 may be communicatively coupled to the pinging light source 216 and the light detector 216.

The console controller 224 may calculate the position of the movable device P(X, Y, Z) by calculating a phase shift in the received light 210.1, 210.2, 210.3 compared with the emitted light 212. The system 200 may operate as follows. The modulation generator 226 may generate a simple sinusoidal modulation of the light source 230 at frequency f. Light source 230 may emit light 212 which may strike the light detector 216 of the movable device 212. The light detector 216 may generate an electrical signal that is modulated based on the phase of the light 212. The movable device controller 212 may then generate a signal for the reply light source 230 to emit light 210 based on the modulated electrical signal generated by the light detector 216. The emitted light 210 of the movable device 210 may then strike the light detectors 222 of the console 220. The light detectors 222 may generate electrical signals that are modulated based on the emitted light 210. The console controller 224 may then calculate the position P(X,Y,Z) of the movable device 210 based on calculating the phase shift, φ, of the received light 210 from the emitted light 212. The simple sinusoidal modulation of the light source 230 at frequency f described above may be termed a characteristic of the light and this same characteristic may be returned to the console 220 by the movable device 210.

In an embodiment, the light source 230 may be considered to be located at the origin of the coordinate system, the light detector 222.1 may be at P(−S_{X}/2, 0, 0), and light detector 222.3 may be at P(S_{X}/2, 0, 0), for a separation distance of Sₓ between the light detectors 222.1 and 222.2. In an embodiment, the light detector 222.2 may be located at P(0, S_{Y}, 0) for a separation distance of Y between the light detector 222.2 and the light source 230.

The console controller 224 may calculate a round trip time or the total delay Tₖ (for k=1, 2, 3) for the emitted light 212 to travel from the light 230 of the console 220 to the light detector 216 of the movable controller 210 (denoted T_{CM}), and then for the emitted light 210 to travel from the light source 230 of the movable device 210 to the light detectors 222 of the console 220 (denoted T_{Mk}, for k=222.1, 222.2, 222.3). Denoting Tₑ to be the delay due to the electronics between the light detector 216 receiving the light 212 and the light 216 emitting light 210, and the delay in the console controller 224 receiving the electrical signals from the light detectors 222 after receiving the light 210, then the console controller 224 may calculate the total time delay from the light 230 to each of the light detectors 222 by using the following equation:

τₖ=τ_{CM}+τₑ+τ_{Mk} 1.

where k refers to each of the light detector 222.1, 222.2, and 222.3. And as discussed above T_{CM}=the time delay from the light 230 to the light detector 216; τₑ=the time delay due to the electronics; and τ_{Mk}=the time delay from the light 216 to each of the three light detectors 222.

The console controller 224 may calculate the distance from the console 220 (light 230 which is at the origin (0,0,0)) to the light detector 216, which is approximated to be at P(X, Y, Z) by using the following equation:

cτ_{CM}=\sqrt{(X−0)²+(Y−0)²+(Z−0)²} 2.

Where c=speed of light. This equation may be used by the console controller 224 because the distance between two points 1 and 2 in Euclidian geometry can be calculated by Distance=\sqrt{(X₁−X₂)²+(Y₁−Y₂)²+(Z₁−Z₂)²}.

The console controller 224 may calculate the distance from the light 216 to the light detectors 222.1, 222.2, and 222.3 by using the following equation:

cτ_{M,222.1}={square root over (((X−(−S/2))²+(Y−0)²+(Z−0)²)} 3.

cτ_{M,222.3}=\sqrt{(X−S/2)²+(Y−0)²+(Z−0)²} 4.

cτ_{M,222.2}=\sqrt{(X−0)²+(Y−S_{y})²+(Z−0)²} 5.

where c=speed of light.

The console controller 224 may calculate the phase shift

φ_{K}=f2πτ_{K}, for k=222.1, 222.2, 222.3. 6.

The phase shifts φₖ=2πfτₖ, represent the measurement of the delays. During implementation, one may choose a low enough frequency f so that all delays of interest produce phase shift less than 2π.

The console controller 224 may calculate the position of the movable device 210 P(X,Y,Z) by substituting in the above equations the wave number, k=2πf/c and by applying Taylor series to the first order:

$$\begin{matrix}{φ}_{1} \approx kr + kr + ( \frac{k}{2} ) \frac{Sx + {( S / 2 )}^{2}}{r} . & 7 \\ {φ}_{2} \approx kr + kr + ( \frac{k}{2} ) \frac{- Sx + {( S / 2 )}^{2}}{r} . & 8 \\ {φ}_{3} \approx kr + kr + ( \frac{k}{2} ) \frac{{S}_{y} y + {S}_{y}^{2}}{r} . & 9\end{matrix}$$

where r=r=\sqrt{x²+y²+z²}. In the above equations, the console controller 224 has subtracted the fixed phase shift caused by the internal delays in the electronics τₑ. The console controller 224 may calibrate for or calculate the internal delays in the electronics τₑ. The console controller 224 may use iterative methods or solve the nonlinear simultaneous equations above.

One solution to the equations above is provided below, which may be calculated by the console controller 224 or used directly by the console controller 224.

$$\begin{matrix}r \approx \frac{{φ}_{1} + {φ}_{2}}{4 k} . & 10 \\ x = \frac{{φ}_{1}^{2} - {φ}_{21}^{2}}{4 {k}^{2} S} . & 11 \\ y = \frac{( {φ}_{1} + {φ}_{2} ) ( 2 {φ}_{3} - {φ}_{1} - {φ}_{2} )}{4 {k}^{2} {S}_{y}} . & 12\end{matrix}$$

In an embodiment, techniques from AMCW radar and lidar systems may be used by the system 200 where two frequencies are used such that the phase shift of a beat frequency is less than 2π for the maximum delay. In an AMCW system, light is amplitude modulated by one or two tones and the phase delay is measured. The phase delay is proportional to the light travel time and hence the distance. In an FMCW system, a periodic frequency chirped output is produced. The distance to the object is then estimated by beating the received signal with the outgoing signal. Due to frequency chirp, the beat frequency becomes proportional to the travel time.

FIG. 2B illustrates a system 200 according to an embodiment of the present invention. In an embodiment, the movable device 110 may include a reflective surface 235 and the light 212 may strike the reflective surface 235 which then reflects light 215. In an embodiment, the console controller 224 calculates the position P(X,Y,Z) as discussed above. In an embodiment, the movable device 110 may include both reflective surface(s) 235 and light detectors 216 and light source(s) 230 (see FIG. 2A). The console controller 224 may distinguish between the emitted light 210 (of FIG. 2A) of the light source(s) 230 and the reflected light 215 by calculating the delay due to electronics of the movable device.

### Multiple Light Sources May Be Tracked By Using Frequency or Using Time Modulation or by Encoding the Identity of the Light Sources

The console controller may calculate the position of multiple light sources using time modulation. For example, each light source may be turned on-off in a predetermined sequence such that only one of the light sources is on at any given time. In this embodiment, only the coordinate corresponding to a particular light source will be measured during a prescribed time interval. Thus, the console controller may calculate positional data for all of the light sources on a time sharing basis. In an embodiment, the light sources may be pulsed and individual light sources given a window in time when each one is pulsed. The console controller may then calculate the centroid of each of light source for each window of time.

Alternatively, the console controller may distinguish between the light sources using frequency domain. For example, the light sources may be modulated at unique frequencies fₖ. The current I generated by the light detectors in response to receiving incident light from the light source of the movable device may include frequency components characterized by these modulations, such as:

$$I ( t ) = {\sum }_{k = sources}^{ } \int {i}_{k} ( x ) cos [ 2 π {f}_{k} t ] x d x . \qquad 13$$

In the above equation, iₖ(x) represent the individual contributions from each of the movable device light sources generated by the light detectors. The console controller may by using the above equations demodulate the current I corresponding to each of the iₖ(x) by demodulating the current I at each of the frequencies fₖ. By calculating the equations above the console controller may discriminate between the electrical signals generated by the incident light of two or more light sources using frequency demodulation. The console controller may then calculate the positions of the light sources as described herein. Thus the console controller may calculate the location of multiple modulated light sources and by repeatedly calculating the location of multiple light sources the console controller may track the multiple light sources.

Alternatively, the console controller may distinguish between the light sources by an encoding scheme. For example, each light source may encode a number in the transmitted light that is decoded by the console controller and used to identify the light source.

Calculating Rotation

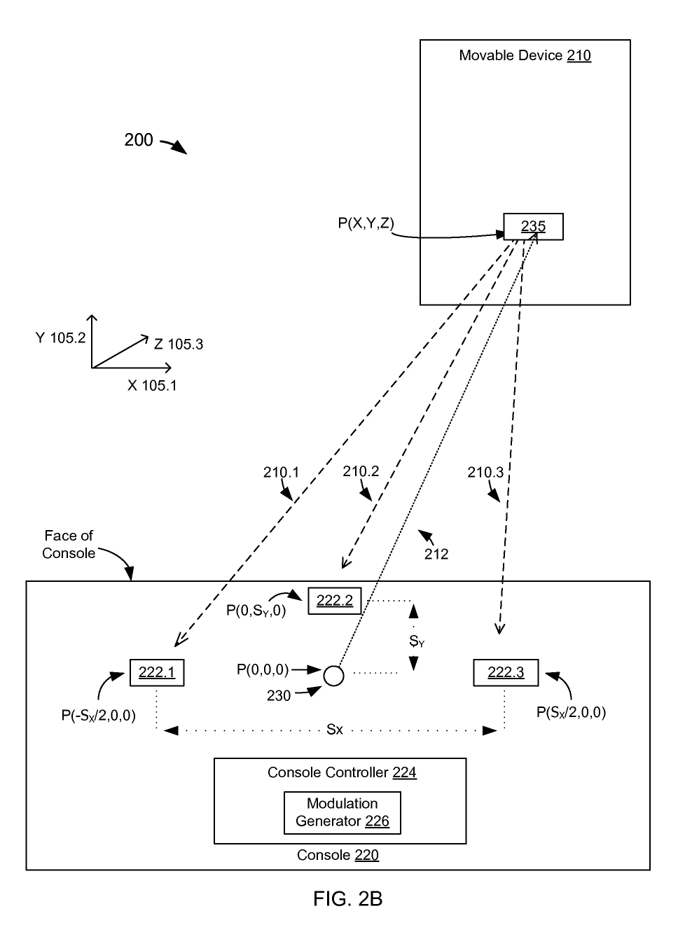

FIG. 3 illustrates an embodiment for calculating the rotation of a movable device 340. A controller (not illustrated) of the console 310 transmits light (not illustrated) from a light source 390, which is received at an light detector 380 of the movable device 340. The controller (not illustrated) of the movable device 340 emits light in response to receiving light from the light source 390. The controller of the console 210 receives light 320 at two light detectors 360 separated by a fixed distance S_{D} 370 from two light sources 330 that are placed on the movable device 340 and separated by a fixed distance l 350 along the x-axis. The controller of the console 310 may distinguish between the two light sources 330 and calculate the position of each of the light sources 330 by using the methods and apparatuses disclosed herein. The controller of the console 310 may then based on the geometry of the movable device 340 calculate the orientation of the movable device 340. Since the positions of each of the light sources 330 is determined independently, the controller of the console 310 may calculate the directed segment (length and orientation) between light sources 330. The controller of the console 310 may use the directed segment to calculate the orientation and location of movable device 340 in space. For example, in an embodiment, the controller of the console 310 may calculate the rotation about the Y-axis based on changes in the measured length vector of the distance between the two light sources 330 as (lₓ,l_{z})=(l cos(θ),l sin(θ)), where θ is the rotation about the Y-axis. Similarly, the controller of the console 310 may calculate the rotation about the X-axis. In an embodiment, additional light sources 330 separated along the y-axis are used to provide higher sensitivity to X-rotations. The controller of the console 310 may track the rotation of the mobile device 340 by repeatedly measuring the rotation. The role of the light sources 330 and the light detectors 360 can be reversed as discussed below. Multiple light sources 330 may be attached to a rigid or flexible body and the orientation of the rigid body or parts of flexible body may be calculated. In an embodiment, the moveable device 340 may have multiple light detectors 380. In an embodiment, the moveable device 340 may have multiple controllers (not illustrated).

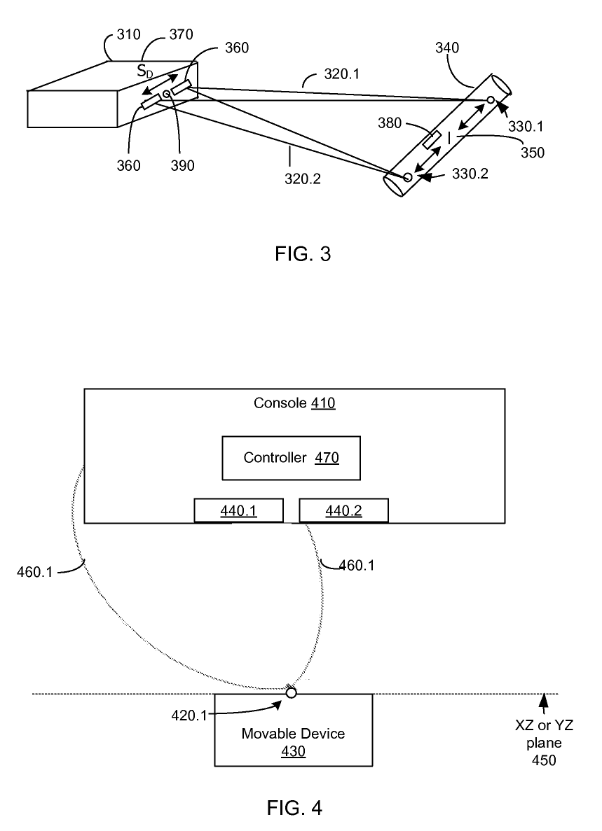

FIG. 4 illustrates an embodiment for calculating the rotation of a movable device 430. A movable device 430 has a light source 420.1 that emits light 460.1 and is detected at the light detectors 440.1 and 440.2 of the console 410.

The controller 470 may calculate the angle of the light source 420.1 based on the currents generated at the two light detectors 440.1 and 440.2. The currents generated at the two light detectors 440.1 and 440.2 may be based on the total light intensity striking the two light detectors 440.1 and 440.2. For example, in FIG. 4, light detector 440.1 will generate more current than light detector 440.2 due to the angular distribution of the intensity of the light source 420.1 and the position of the light source 420.1. The controller 470 may use the relative ratio of current generated at the light detectors 440.1 and 440.2 to measure the angle of the light source 420.1 based on a known angular distribution of the light source 420.1 which varies in different directions.

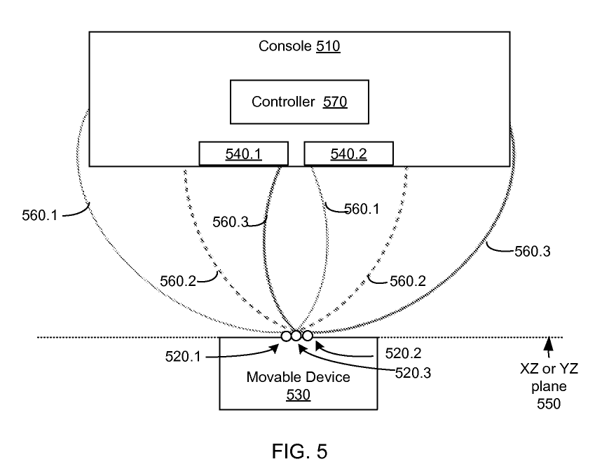

FIG. 5 illustrates an embodiment for calculating the rotation of a movable device 530 with multiple light sources 530. Each light detector 540 generates currents from the incident light striking the respective light detector 540. The controller 570 may distinguish between the light sources 520 using methods and apparatuses disclosed herein. The light sources 520 may each be oriented differently and the light sources 520 may be separated from one another. The light sources 520 may each have an angular distribution that may be used by the controller 570 to calculate the angle of the light source 520. The use of multiple light detectors 520 may increase the accuracy of calculating the angle of the light source(s) 520.

As disclosed herein, the controller may calculate the rotation about the Z-axis using information generated at light detectors. Thus, using the methods and apparatuses disclosed herein the rotation of a movable device 530 may be calculated by the controller.

In an embodiment, the light sources 520 may be part of the console 510 and the light detector 520 part of the movable device 530. In an embodiment, the light sources 520 may be spaced out rather than being pointed at different angles. In an embodiment, the controller 570 may calculate the angle of the light source(s) 520 based on voltages generated at the light detectors 540.

Role of Light Source and Light Detector May Be Reversed

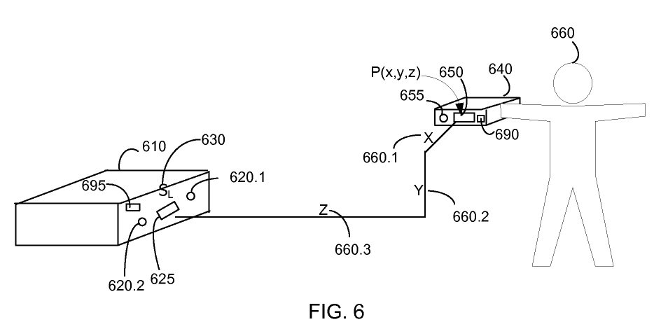

FIG. 6 illustrates an embodiment of the present invention where the roles of the light sources and light detectors are reversed. The system of FIG. 6 includes two light sources 620 and an light detector 625 on a console 610 and a light detector 650 and a light source 655 on a movable device 640 being held by a person 660. The light source 655 emits light (not illustrated) that is detected by the light detector 625 that generates electrical signals. In response the two lights 620.1, 620.2 emit light that is synchronous with the generated electrical signals which may strike the light detector 650 of the movable device 640. The movable device 640 may calculate the position P(X,Y,Z) 650 of the movable device 640 based on the received light and the phase of the light emitted from the light source 655. The movable device 640 may transmit the calculated position to the console 610 using an IR transmitter 690. The console 610 may receive the position 650 of the movable device 640 by an IR receiver 695. As illustrated below, the roles of the light detectors 650 and the light sources 620 may be interchangeable.

In an embodiment, the IR transmitter/receiver 690, 695, may be other types of communication, e.g. the movable device 640 may be wired directly to the console 610, or the movable device 640 may communicate with the console 610 using radio waves. In another embodiment, the receiver may include an avalanche photodiode.

### Embodiments of the Controller

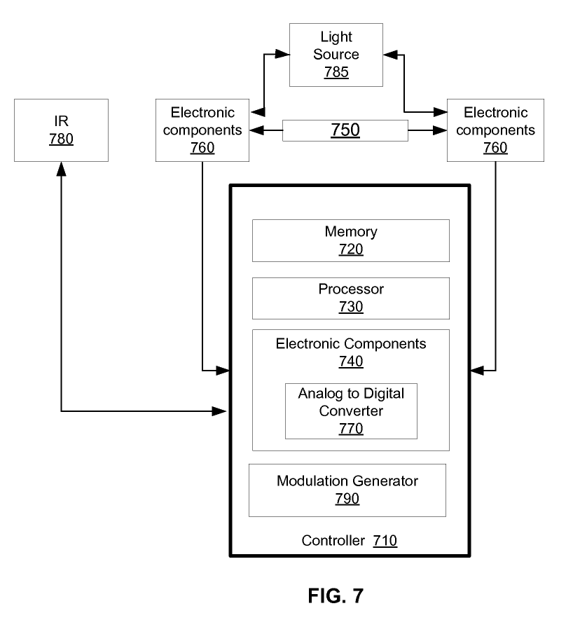

FIG. 7 illustrates an embodiment for the controller 710. The controller 710 may be part of the console and/or the movable device. The controller 710 may include one or more memories 720, one or more processors 730, electronic components 740, and the controller 710 may communicate with an infra-red (IR) transmitter and/or receiver 760. The controller 710 may be directly communicatively coupled to one or more light detectors 750 or the controller 710 may be directly communicatively coupled to electronic components 760, and the electronic components 760 may be directly communicatively coupled to the one or more light detectors 750. The controller 710 may be communicatively coupled to one or more light sources 785 or the controller 710 may be communicatively coupled to electronic components 760, and the electronic components 760 may be communicatively coupled to the one or more light sources 785. The controller 710 may include a modulation generator 790 for sending signals to a light source 785. The controller 710 may calculate the position of the movable object by receiving data collected from the light detectors 750 and based on emitted light from a light source 785. The data may be processed by the electronic components 760 outside the controller 710 before being received by the controller 710. The controller 710 may include an analog to digital converter 770 for converting the analog data from the light detectors 750 and/or the electronic components 760 to digital data for processing by the processor 730. The memory 720 may be RAM and/or ROM and/or any type of memory able to store and retrieve instructions and may include program instructions for determining the position and/or rotation of one or more movable devices. The processor 730 may be a computer processor as is well known in the art. The light detectors 750 may be any type of photo detectors 750 as is known in the art.

Multiple controllers 710 may be used to determine the position of the movable device. The controller 710 may perform only part of the calculating necessary to determine the position of the movable device. The electronic components 740, 760 may include operational amplifiers, amplifiers, a differencing and summing instrumentation amplifier configurations to measure the location of the spot of light, analog to digital converters, a pair of current detectors, each coupled to the PSD edges, or two pair of current detectors for a two-dimensional light detectors, simple wires for connecting the current detectors to the other electronic components, a pair of differential amplifiers to compare the left-edge and right-edge currents from each light detector, or other electronic or electrical circuitry for implementing the functionality of the present invention. The electronic components may be positioned or grouped in many ways. For example, there may be one differential amplifier per light detector or the light detectors may share a common differential amplifier or there may be no differential amplifier or there may be one or more differential amplifiers as part of the controller. Positional information for the movable device may be computed entirely by one device or the computations may be divided among two or more devices.

The controller 710 may include a single digital signal processing engine that can separate and track multiple light sources. The controller 710 may receive data from light detectors 750 collected at a remote device and communicated to the controller 710. For example, a remote game controller, which may include the light detectors 750 and then communicate data from the light detectors 750 to the controller 710 for the controller 710 to calculate the position or rotation of the remote controller. The controller 710 may be communicatively coupled to many light detectors 750 and/or light sources. The controller 710 may be configured to modulate a light source either in time or frequency so that the light source may be distinguished from other light sources. The controller 710 may be configured to calculate the rotation of an object based on the spectrum of light received from multiple light sources. The controller 710 may be configured to calculate the location of an object based on the difference in light received from two light sources in response to a sent light.

### Embodiments of the Movable Device

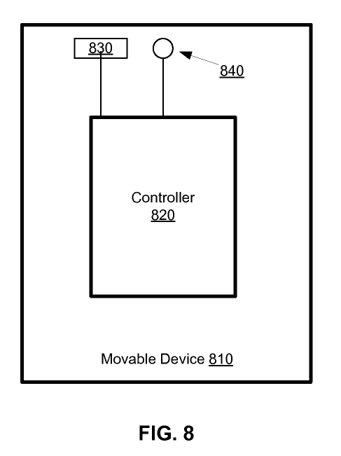

FIG. 8 illustrates an embodiment of the present invention of a movable device 810. In an embodiment, the light detector 830 receives modulated light from a light source of the console (not illustrated) and amplifies and emits a reply light. The modulation of the reply may be based on the modulation of the received modulated light. The light sources 840 may be LEDs or lasers or any type of light source. There may be multiple light sources 840 that may be used for determining the rotation of the movable device and/or may be used for redundancy (which may help to insure that the reply light is received by the console.) The light detectors 830 may be any type of light detectors as is known in the art. There may be multiple light detectors 830 for redundancy to help insure the movable device 810 receives the modulated light from the console. The light detectors 830 and the light source 840 may be electronically connected to the controller 820. There may be multiple light sources 840 on the movable device 810 with at least two of the light sources 840 sending replies in different allotted time slots or different frequencies or with different modulations where the modulations are based on the modulation of the received light. In operation, the movable device 810 may receive the modulated light and amplifies and emits light based on the received modulated light. The movable device 810 may have fixed delay between receiving the modulated light and sending the reply modulated light. This fixed delay may be known by the console and used to computer the distance from light to the console. The movable device may alter the modulation of the light based on the received modulation of the light. The movable device, may only send light during a fixed allotted time slot so that the console can differentiate between different light sources.

### Embodiments of the Movable Device

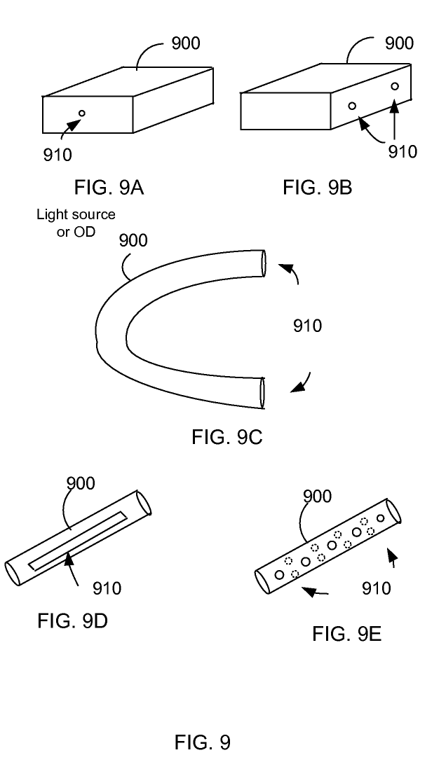

FIG. 9 illustrates embodiments of the present invention. FIG. 9A illustrates the movable device 900 with a one light detector 910 or one light source 910. FIG. 9B illustrates the movable device 900 with two light sources 910 or two light detectors 910.

FIG. 9C illustrates the movable device 910 with two light sources 910 or light detectors 910. The movable device 910 is shaped in a manner so that a player of a video game would be less likely to interfere with the transmission of light between the console and the movable device, or the transmission of light between the movable device and the console.

FIG. 9D illustrates the movable device in a rod shape with large light source 910 or a large light detector 910. FIG. 9E illustrates the movable device 900 in a rod shape with many light sources 910 or many light detectors 910.

The many light sources 910 reduce the risk that the person using the movable device will interfere with the light source 910 reaching the console. The many light sources may also be time and/or frequency modulated so that the console can individually calculate the position of the many light sources and use the position information to determine rotational information of the movable device using the methods and apparatuses disclosed herein. The light sources 910 may be light detectors 910 and the many light detectors 910 would reduce the risk that a person would interfere with receiving light from the console. The movable devices 910 may also include other electronic components including sensory feedback devices, input devices and output devices, e.g. input and output devices that are found on game controllers, communication devices for transmitting information to the console, etc. The movable device may be tracked by repeatedly determining the position of the movable device.

Additional light detectors may be used to increase the accuracy of locating the other device (console or movable device) device or to increase the area of sensitivity of the device or to decrease the possible of the light detectors being obstructed. For example, if the light detectors are located on the movable device, additional light detectors would increase the likelihood of the light detector not being blocked from detecting the light source. Or if two pairs of light detectors were provided on the console then they would be separated to increase the likelihood of detecting the light source. Alternatively, additional light detectors and/or light sources may be used that are separated from the console.

Several embodiments of the present invention are specifically illustrated and described herein using an example of a game console and controller to track the motion of the players. However, it should be understood that the gaming console example is used for narrative simplicity only and that the present invention applies equally well for any application requiring location monitoring. Other applications may include in-home patient monitoring and various robotic navigation systems where a movable robot operates according to motion tracking such as lawn-mowers, vacuum cleaners, fork-lifts, and robotic arms for pick and place.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

We claim:

1. A device for calculating a position of a movable device, comprising:
two light detectors, the light detectors each receiving light from the movable device and each generating electrical signals in response to the light from the movable device;
a light source to transmit light to the movable device;
a controller communicatively coupled to the light detectors to calculate a position of the movable device from the electrical signals generated by the two light detectors and from a roundtrip time representing a time for the device to receive a reply at each of the two light detectors from the movable device in response to the light transmitted to the movable device.

2. The device of claim 1, wherein the light source transmits light having a predetermined characteristic and the light detectors receive a reply light signal having the same characteristic and the controller calculates the roundtrip time based on a time difference between the transmitted light and the reply light signal.

3. The device of claim 1, wherein the controller calculates the roundtrip time at each of the two light detectors to receive a reply light signal from the movable device by calculating a phase shift between light emitted from the light source and the reply light.

4. The device of claim 1, wherein the controller calculates the position of the movable device in two dimensions.

5. The device of claim 1, further comprising:
a third light detector, the third light detector receiving light from the movable device and generating electrical signals in response to the light from the movable device; and
the controller calculates the position of the movable device in three dimensions from the electrical signals generated by the two light detectors and the third light detector and from a roundtrip time representing a time for the device to receive the reply at each of the two light detectors and the third light detector from the movable device in response to the light transmitted to the movable device.

6. The device of claim 1, wherein the electrical signals are analog signals with strength proportionate to the received light.

7. The device of claim 1, wherein the controller comprises:
a processor to execute program instructions representing a game, and
a computer display to display a player-controlled object of the game, wherein the processor uses periodically calculated position data representing movement of the movable device light source to move the play-controlled object on the display.

8. The device of claim 1, wherein the device is a game console that receives light emitted from a movable game controller.

9. The device of claim 8, wherein the game controller includes a transmitter for communicating position data to the game console.

10. The device of claim 9, wherein the game controller includes a transmitter for communicating position data to the game console.

11. The device of claim 1, wherein the controller is configured to:
calculate rotational information for the movable device, the movable device including at least two light sources, the two lights of the light sources distinguishable by at least one of time and frequency.

12. The device of claim 11, wherein the controller is configured to calculate a directional vector between the light sources.

13. The device of claim 1, wherein the controller is configured to:
calculate rotational information of a light source of the movable device based on the generated electrical signals and a known angular distribution of the light source.

14. The device of claim 13, wherein the controller is further configured to:
calculate rotational information of a second light source of the movable device based on the generated electrical signals and a known angular distribution of the second light source, the two lights of the light sources distinguishable by at least one of time and frequency; and further configured to:
calculate rotational information for the movable device.

15. The device of claim 1, wherein the electrical signals are currents.

16. The device of claim 1, wherein the electrical signals are voltages.

17. The device of claim 1, further comprising analog to digital converters respectively provided in signal paths between the light detectors and the controller.

18. The device of claim 1, further comprising:
an amplifier and differencing and summing instrumentation communicatively coupled to at least one light detector and communicatively coupled to the controller.

19. The device of claim 1, wherein the controller comprises:
a processor;
a memory communicatively coupled to the processor; and
wherein stored in the memory are instructions that when executed by the processor cause the processor to calculate two of the coordinates of the position of the light source based on measurements at the light detectors.

20. The device of claim 1, wherein the device is further configured to track the position of the light source by repeatedly calculating the position of the movable device.

21. The device of claim 1, wherein the calculation includes at least two of the six degrees of freedom of the light source.

22. The device of claim 1, wherein the calculation includes at least three of the six degrees of freedom of the light source.

23. A movable device for calculating a spatial position of the movable device relative to a console, comprising:
two light detectors, the light detectors each receiving light from the console and each generating electrical signals in response to the received light;
a light source to transmit light to the console;
a controller communicatively coupled to the light detectors to calculate a position of the movable device from the electrical signals generated by the two light detectors and from a roundtrip time representing a time for the movable device to receive a reply at each of the two light detectors from the console in response to the light transmitted to the console.

24. A system, comprising:
the movable device of claim 23, and
a console, having a pair of light emitters mounted thereon for regenerating light received at the light detectors.

25. A system, comprising:
the movable device of claim 23, and
a console, having a pair of light reflectors mounted thereon for reflecting light from a source to the light detectors.

26. A device for calculating the rotation of a movable device, comprising:
an light detector;
a controller communicatively coupled to the light detector, configured to calculate rotational information of a movable device based on data generated by the light detector from receiving light from at least two light sources of the movable device.

27. A device for calculating a position of a movable device, comprising:
two light detectors, the light detectors each receiving reflected light from the movable device and each generating electrical signals in response to the reflected light from the movable device;
a light source to transmit light to the movable device;
a controller communicatively coupled to the light detectors to calculate a position of the movable device from the electrical signals generated by the two light detectors and from a roundtrip time representing a time for the device to receive the reflected light at each of the two light detectors from a reflective surface of the movable device due to the light transmitted to the movable device.

28. A method for calculating a position of a movable device, comprising:
responsive to incident light received from the movable device at multiple locations, generating differential signals at each location, the differential signals of each location representing a location of light incidence on a light receiving surface,
transmitting an outbound signal to the movable device;
receiving a signal from the movable device representing a reply to the outbound signal; and
based on a transmission latency between the output signal and the reply signal and based also on the differential signal, calculating the position of the movable device.
